(19) United States
(12) Patent Application Publication
(10) Pub. No.: US 2016/0227408 A1
(43) Pub. Date: Aug. 4, 2016

(54) SYSTEMS, METHODS AND DEVICES THAT ALLOW THE HOSPITALITY INDUSTRY AND GUESTS TO CONFIRM IDENTITY AND PERFORM IDENTITY SECURE TASKS

(71) Applicant: FINGI INC., New York, NY (US)

(72) Inventor: Eran SHERIN, New York, NY (US)

(21) Appl. No.: 15/021,684

(22) PCT Filed: Sep. 12, 2013
(86) PCT No.: PCT/US13/59556

§ 371 Date: Mar. 11, 2016

(51) Int. Cl. H04W 12/06; H04L 29/06

(52) U.S. Cl. CPC H04W 12/06; H04L 63/08; H04L 63/083; H04L 63/0861

(57) ABSTRACT

A network system supporting the use of mobile devices for biometric identification of guests of the hospitality industry is disclosed. Mobile devices can be used by guests to access a number of hotel services and conversely can be used by hotels to contact and manage guests. An increasing number of mobile devices contain one or more method of biometric identification via a built in component of the device. This system built into a mobile device may be used by the hospitality industry via a networked system to confirm the identity of users in order to perform identity-secure tasks. The means by which a user's identity can be confirmed include both well-established means such as password or PIN entry, as well as newly developed and developing biometric means including: retinal scan, facial recognition, infrared (IR) or near IR heat map scan of the face or palm, voice recognition, fingerprint scan, or voice recognition. Such biometric identification is accomplished by a biometric sensor available on an increasing number of mobile devices and peripherals.

### FIELD OF THE INVENTION

The subject invention relates to the use of identification abilities of mobile electronic devices, such as passwords, identifiers, and biometrics, which allow a hotel guest or resident to interface with a hotel or other property and be securely identified by the networks and network operators connected to those devices.

### BACKGROUND OF THE INVENTION

Due to the decrease, in recent times, of air travel, and the burgeoning of the global middle class, the travel and hospitality industry are growing and changing faster than ever before. Hotels in particular are meeting this demand with increased automation by allowing guests to do an increasing number of transactions remotely, for instance using mobile devices. While this development has led to an increased convenience and efficiency for both the hotel and the guest, it has led to a rise in problem common to all internet transaction but especially pertinent to the hotel industry: positively identifying a user.

Furthermore, the hotel industry in particular is often subject not only to the security requirements of credit card companies, but that of governments, especially when dealing with foreign travelers. Many countries require special procedures for hotels when they house a foreign national, such as visually identifying them, retaining a copy of documents, or even contacting the government with appropriate information. This regulation makes it hard or impossible for many travelers to use the many automated features of hotels such as checking in via their phone.

A better method of user identification is needed to allow the hotel industry to run efficiently, especially as more of the services of a hotel become available to the user via a mobile device.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to allow the identification of a hotel guest by a server using an application on a mobile device.

It is also an object of the present invention to allow hotels to allow a user, once positively identified, to perform tasks which are then allowed.

It is also an object of the present invention to allow hotels to perform certain automated tasks upon positive or negative identification of a guest

It is also an object of the present invention to allow a hotel to comply with government regulation of guest identification using a server based remote identification system.

### SUMMARY OF THE INVENTION

This disclosure is directed at system which integrates many or all of a hotel's services into a single server or cloud based system which connects directly with an electronic device to communicate with a guest. This cloud based system can then utilize one or more user identification capabilities of a user's phone in order to confirm the identity of the user in order to perform a secured function for the guest, hotel, or other entity using the network. The means by which a user's identity can be confirmed include both well-established means such as password or PIN entry, as well as newly developed and developing biometric means including: retinal scan, facial recognition, infra red (IR) or near IR heat map scan of the face or palm, voice recognition, fingerprint scan, or voice recognition. Such biometric identification is accomplished by a biometric sensor available on an increasing number of mobile devices and peripherals.

Once the identity of a user has been confirmed, server or cloud based system can then perform automated tasks or tasks at the direction of the guest or a 3^{rd} party which are identity secured, such as making charges on a credit card or opening a locked door. Additionally, in some instances, the invention may be used for the purpose of complying with government regulation by positively identifying a guest and supplying and/or storing appropriate documents such as a passport or visa.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of an electronic device according to one embodiment of the invention.

FIG. 2 is a schematic diagram of a system for identifying a hotel guest using mobile device according to one embodiment of the invention.

FIG. 3 is a flow chart giving an example of a method by which a server may determine and use the identification of a user of a mobile device.

FIG. 4 shows a schematic functional block diagram of an overview of a system providing a user access to a server which is connected to a number of other devices and services allowing the user access to a number of different systems and resources.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this detailed description section.

It will be apparent to those of ordinary skill in the art that although the systems and methods of this invention are often embodied in this description as applying to hotels, hotel rooms, and hotel guests, that the same systems and methods can be applied to other fields as well, and that the use in this document of these terms is used for simplicity rather than as a limitation of the scope of the invention. For instance the guest communication center herein described is an invention not just for hotels but for any facility, such as homes, condominiums, apartment complexes, cruise ships, office buildings or other structures or businesses. Likewise, all of the devices, methods, and systems herein described can be used for any of these businesses and locations as well. Therefore the terms hotel, hotel room, and guest should not be read as limiting the scope of this invention to the hospitality industry.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” “electronic device” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Near Field Communications (NFC) link, Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, Wi-Fi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoW), Unlicensed Mobile Access (UMA), etc.

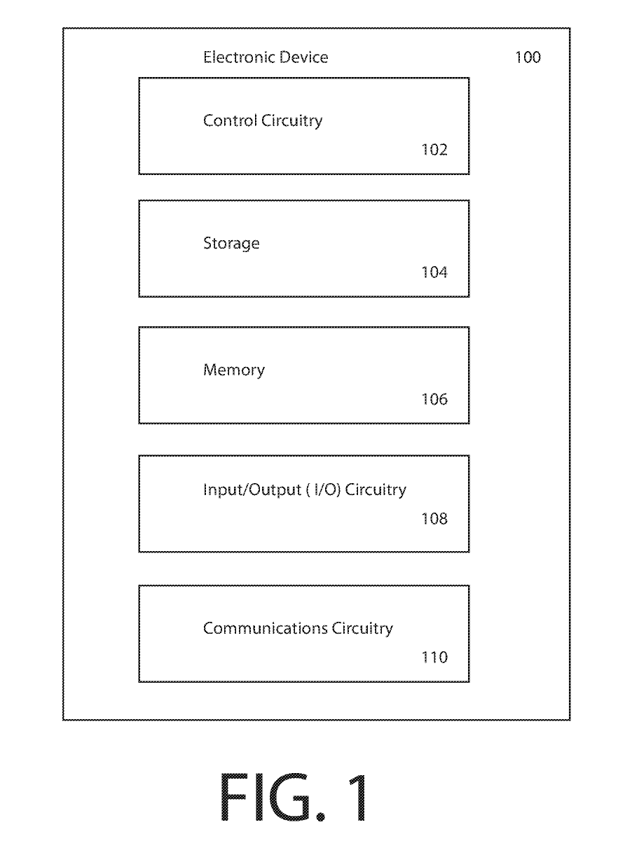

FIG. 1 is a schematic view of an illustrative electronic device for providing an application operative to interface with a hotel system in accordance with some embodiments of the invention. Electronic device 100 can include control circuitry 102, storage 104, memory 106, I/O circuitry 108, and communications circuitry 110. In some embodiments, one or more of the components of electronic device 100 can be combined or omitted. In some embodiments, electronic device 100 can include other components not combined or included in those shown in FIG. 1 (e.g., motion detection components, a power supply such as a battery or kinetics, a display, a bus, a positioning system. or an input mechanism), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer or a docking station.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface.

Storage 104 can include, for example. one or more storage mediums including a hard-drive, solid state drive, flash memory, permanent memory such as ROM. any other suitable type of storage component, or any combination thereof. Storage 104 can store, for example, media data (e.g., music and video files), application data (e.g., for implementing functions on electronic device 100), firmware, user preference information data (e.g., media playback preferences), authentication information (e.g. libraries of data associated with authorized users), lifestyle information data (e.g., food preferences. exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM and/or one or more different types of memory used for temporally storing data. In some embodiments, memory 106 can also be used for storing data used to operate electronic device applications, or any other type of data that can be stored in storage 104. In some embodiments, memory 106 and storage 104 can be combined as a single storage medium.

I/O Circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive or resistive sensing mechanic, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, L4 GHz, and 5.6 GHz communication systems), infrared, GSM, GSM plus EDGE, CDMA, quadband, and other cellular protocols, VOW, Near Field Communications (NFC), or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one or more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled to a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

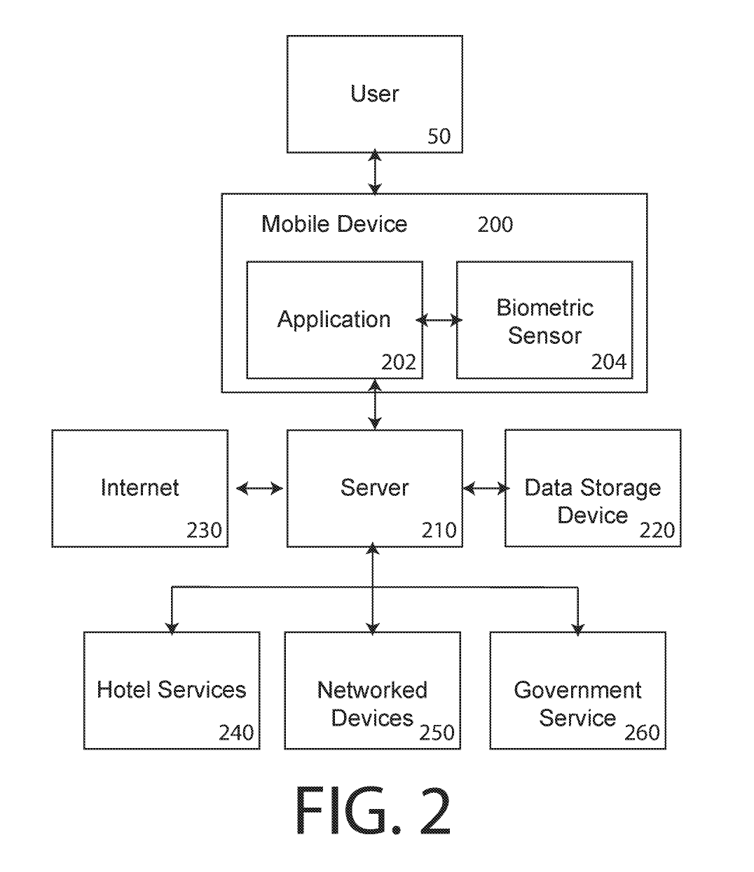

FIG. 2 illustrates a system for hotel and residential properties to allow guests and residents to be securely identified using a mobile device 200, which is a mobile version of electronic device 100, described above, such as a smartphone or tablet computer. The system illustrated demonstrates a system whereby the user 50 interacts with an application 202 installed on the mobile device 200 in such a way as to confirm their identity. The means by which a user's 50 identity can be confirmed include both well-established means such as password or PIN entry, as well as newly developed and developing biometric means including: retinal scan, infrared (IR) or near IR heat map scan of the face or palm, facial recognition, voice recognition, fingerprint scan, or voice recognition. Such biometric identification is accomplished by a biometric sensor 204 available on an increasing number of mobile devices and peripherals.

In the preferred embodiment, the server 210 will be secured using network and data encrypting and will be compliant with PCI standards, as well as any government regulatory standards, especially concerning any biometric or identification data.

In the preferred embodiment, a server 210 will be configured to interact with the application 202 via a secured network interface. The server 210 will be functionally attached to data storage device 220 which it will use to hold a database of users 50. In order to determine the identity of a user 50, the server will use the application 202 to retrieve either the biometric data from the biometric sensor 204 or an alternate identification means, such as a password from the user. Once the server 210 has matched the given data to the stored data to within established identification tolerances, the server 210 may then allow the user 50, a network operator, a third party, or the server 210 itself, to perform identity secure tasks via the internet 230 or using hotel services 240 or networked devices 240.

In some embodiments, once a user 50 has been positively identified by the server 210, the user 50 may then be allowed to perform certain tasks via the mobile device 200 which may be otherwise restricted. Such tasks may include: opening door locks (for instance by NFC interface in the mobile device or audio), making purchases or reservations using a stored payment method or by adding to a bill, checking into and out of a hotel, or any other task where it is advantageous to confirm a user's 50 identity.

In some embodiments, the present invention will allow the server 210 to store and access a copy of a photographed or scanned identification or other government issued document which is associated with a particular user ID in the data storage device 220. For instance, such a system might allow a hotel guest to scan a passport and/or visa on their arrival to a hotel, or to take a picture of these documents themselves, prior to arrival. Such documents may then be uploaded to the server 210 by the application 202 or by hotel staff. From that point, they might then be allowed to bypass the front desk on that stay or future stays as long as those documents remained valid, using instead the identification via the mobile device 200, biometric or otherwise, to be positively identified. In some embodiments, the server 210, may allow access to certain documents and files to a government service 260, such as is required in many countries whereby a government my require to know who is staying in a particular hotel and may ask for a copy of their documents.

As an example of the above, in a country where the government regulation requires that a hotel confirm the identity of a guest upon check-in and retain a copy of a passport and visa, using the present invention, the guest would be able to take a photograph of the required documents using the their mobile device 200 and upload then using application 202 to server 210, which would store the documents along with that guests user ID. When the guest arrives at the hotel, rather than waiting in line to check in, they could simply connect to the hotel's Wi-Fi network or use some other means to securely establish their location and then use the biometric sensor 204 such as a fingerprint scanner to positively identify the guest. In this way, the hotel might satisfy the countries regulations while still allowing the guest a convenient and secure method of check in. In addition, depending on the type, frequency, and consistency of the particular biometric used, the identification might be more accurate than the older method of visual comparison to a passport photo.

In some embodiments, the mobile device 200 will be provided by the guest or resident user 50, such as a previously-owned smartphone or tablet. In other embodiments, the mobile device 200 may be provided by the hotel or property owner to the user. In embodiments where the application 202 is installed on the user 50's own device, the application 202 allows guests to use their mobile device 200 across multiple hotels. The application 202 installed on a guest's own mobile device 200 may be advantageous because: guests can personalize the interface, guests will experience an improved/enhanced and consistent experience across properties, and guests will have access to optional travel-based features that don't require a hotel stay.

In some embodiments, users 50 can create an account and customize their settings and preferences so that they will be automatically applied at any hotel where the mobile device 200 is provided.

In one embodiment, the system includes a mobile device 200 (Dedicated or Application 202 on 3rd Party Device), a Control Device, a 3G SIP Server, a Central Server, and a Bandwidth Optimization Server (HSIA/Firewall/Logging).

In one embodiment of the present invention, a mobile device 200, such as a smartphone, tablet computer, laptop computer or other handheld device runs an application 202, or application 202, which is operably connected to a server 210, which might be located on the hotel property, or may be virtually located in an internet cloud 230.

Some embodiments of the present invention uses a unique technology that enables smartphones to control many aspects of a room including the TV, phone, lights and environmental controls, as well as to be able to present hotel services and interact in a bidirectional manner with hotel PMS systems.

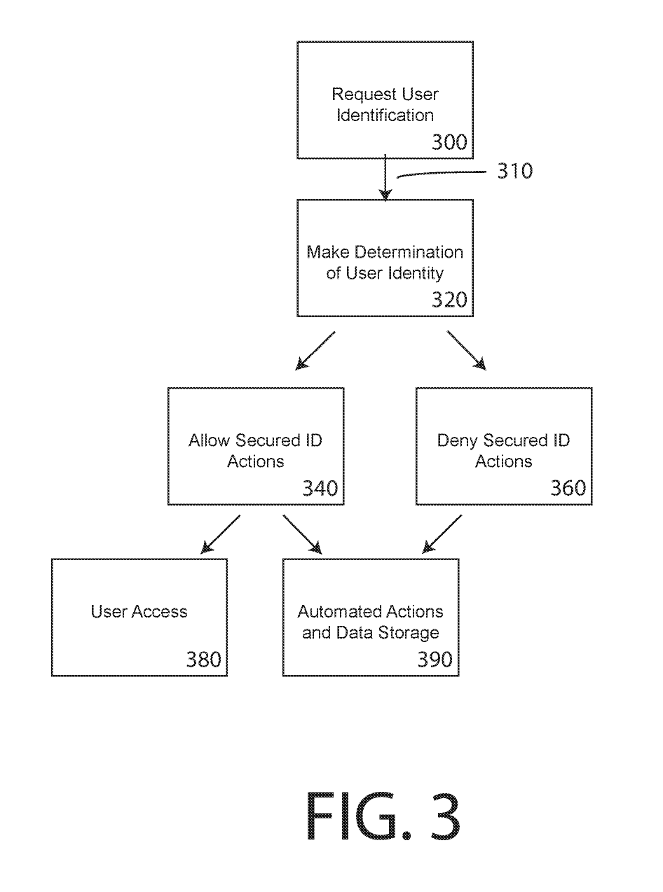

FIG. 3 is a flowchart giving an example method of how the server 210 would, in some embodiments, determine, and utilize a hotel guest's identity. When the server determines that a guests identification is needed, such as when a guest wants to pay for a hotel stay with a stored credit card, the server will request user identification 300. The guest will then use the provided identification means to confirm their identity, such as a fingerprint scanner on their phone. When multiple methods of identification are available, the server may convey to the user which, if any, is available. The mobile device will then send back 310, via a secure network protocol, the identifying information, in this example the fingerprint scan. The server will then make a determination of user identity 320 based on its stored identifying information, here determining if the fingerprint scan is a match within acceptable tolerances to the fingerprint scan on file.

If the user is not positively identified, the server will deny secured ID actions 360 and may take automated actions such as notifying the hotel of the failed identification and storing the failed attempt with the user's data file 390.

If, on the other hand, the user is positively identified, the server will allow secured ID actions 340 such as allowing user access 380 to secure functions, in this case allowing the guest to pay with stored credit card information. In addition, the server can also take automated actions and store data 390 just as it did before, but this time noting a positive identification rather than a negative one.

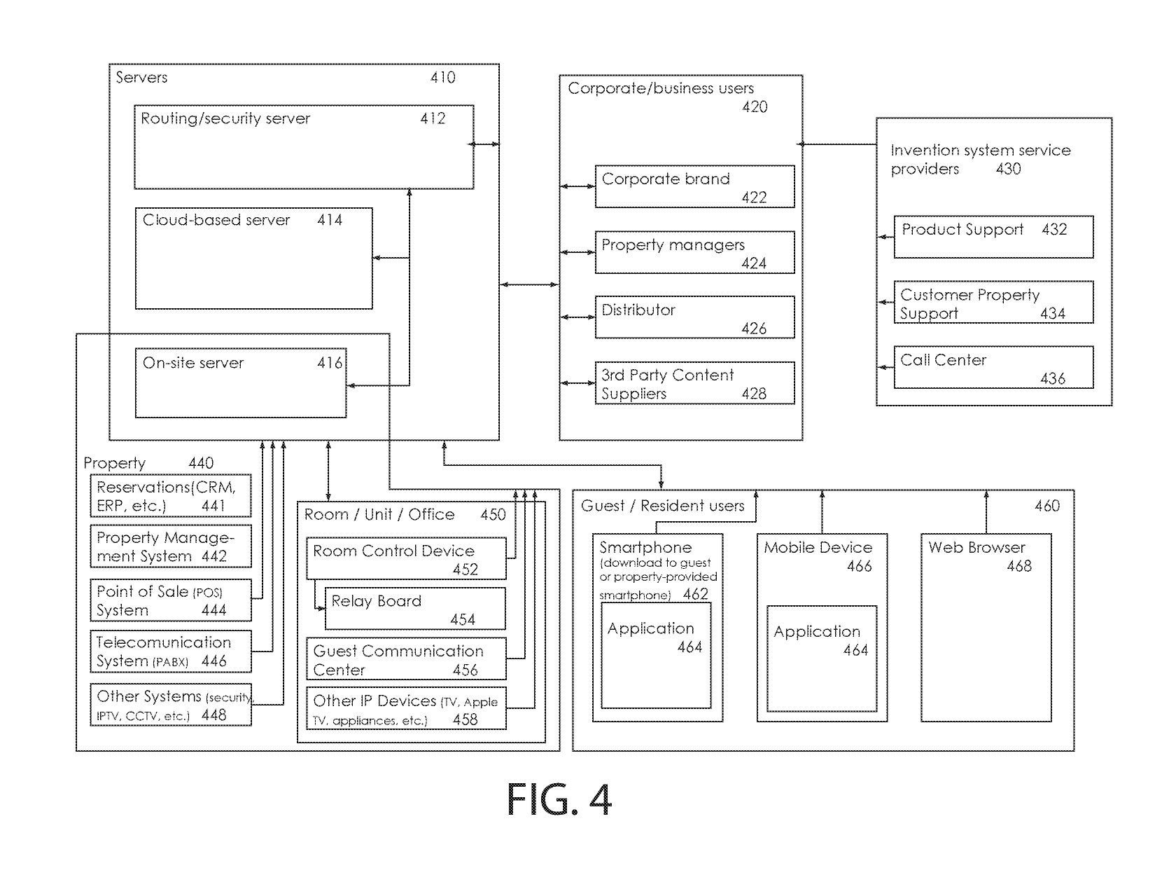

FIG. 4 is a diagram of a of an embodiment of the invention which is the same as in FIG. 2 and the description above, but goes into greater detail for some of the aspects of the invention which are may be used in conjunction with the system of user identification laid out above. The system in FIG. 4 is one configuration of the invention, but other configurations exist. Other configurations may contain additional equipment and systems or may lack some equipment or systems shown in FIG. 4. FIG. 4 in no way limits the invention to this particular configuration shown and described below; it merely uses the configuration to assist an understanding of one way the invention can be implemented.

The server 210 from FIG. 2 above can be, as previously stated, a single server or multiple servers working in parallel or in sequence, as shown in the servers 410 box of FIG. 4. As shown in the diagram, in the embodiment the server system used can contain some, all, or two or more of each of: a routing/security server 412, a cloud-based server 414, and an on-site server 416.

In the shown configuration, in some embodiments, the routing/security server 412 acts as a routing and access server which the users of the system access first when using the system. The routing/security server 412 may the only server which the user can access preliminarily, but then once the user has been processed by the routing/security server 412, the user can access further servers and systems. The purpose of this system is to provide logistics and security to the system. For example, the applications and devices which need to access the system will only need the address of the routing/security server 412, which can then route them to the other systems, rather than having to have the addresses and access information of all possible servers from the start. Additionally, by keeping those IP addresses and access info off of the applications and devices accessible by the users, the security of the system is improved by helping to prevent unwanted access to the other servers and systems. Additionally, since the devices communicate through the routing/security server often, this server can be used to provide support and push software updates to the individual systems which connect to it.

In some embodiments, there may be one or more of either or both of: cloud based server 414 or on site server 416. Cloud-based server 414 can exist at any offsite location which has internet access, or can exist at many sites. On-site server 416 can be located at or adjacent to the business which is using it, and is therefore on the property 440 of the business. Additionally, the invention contemplates that many of the configurations will use either both of these systems and/or several of one or the other in parallel. The purpose of this parallel operation is to distribute the load of user access and to add a layer of redundancy in case one of the servers is for some reason unable to operate.

In some embodiments the property 440 will contain some or all of the diagramed systems in FIG. 4, such as a Reservations system 441, Property Management System (PMS) 442, a Point of Sale (POS) system 444, a PABX or IP telecommunication system 446, and/or other systems 448 such as security, IPTV, CCTC, etc. In some embodiments, these systems will be connected to the Severs 410 via an appropriate network protocol in order to foster access to those systems by users and to allow control and data collection of the systems by the centralized servers. In other embodiments, some or all of these systems can be replaced or supplemented by the centralized server system. For example, the PABX telecommunication system 446 can be replaced by an on-site server 416 or cloud-based server 414 which is configured to run Voice Over IP (VOIP) or other network based telecommunications software to supplement or replace a physical PABX telecommunications system 446 installation. Similarly, in some embodiments, some or all of the listed or other systems 448 can be supplemented or replaced by a server based equivalent.

In addition to the major on property 440 systems explained above, individual rooms, units, or offices 450 will, in some embodiments, contain various room specific devices and systems which are integrated into the system via an appropriate network protocol or other electronic connection. In some embodiments, some or all rooms/units/offices may contain one or more: room control devices 452, relay boards 454, quest communication centers 456, and other IP devices 458 such as Televisions, Apple TV™, or other appliances with network connectivity.

The room control device 452 can be used to adapt any electronic device, such as lights, thermostats, or entertainment systems in a room to be controlled by the server or systems in this invention. The purpose of the room control device 452 is to allow the system to control a device which does not already have a means of network control built in, or devices whose current control means do not or cannot connect directly to the system. The room control device, in some embodiments, has a means of connecting to a network, either through a wired or wireless protocol, and a way of communicating and controlling a particular in room device, such as a serial, modbus, or other communication protocol.

For systems which cannot be controlled by a communications protocol, the room control device 452 can be connected to a relay board 454 to allow control of systems by directly controlling their power. The relay board 454 has, in some embodiments, a communications protocol for connecting to the room control device 452 and an electronic relay for providing power to the connected device. For instance, the relay board 454 can be used to provide power to a light or group of lights, and therefore allow the system to control those lights by telling the room control device 452 to have the relay board 454 provide more or less power to the lights.

The guest communication center (GCC) 456 is used, in some embodiments, to allow a non-mobile access point to the servers 410 in a room, unit, or office 450, in order to allow a user to access the system envisioned in this invention to control devices or accomplish other tasks. The GCC 456 may have a means of communicating via an appropriate network protocol to the servers, to allow a user access, and to tell relay to the server commands from the user or they may also exercise direct control over some individual systems of the room which are directly connected to the GCC 456. The purpose of this system is to allow a user control over some or all of the systems in the room or the property without using a mobile device or a personal computer.

In addition to the room control device 452, relay board 454, and GCC 456, which can be installed specifically to be a part of the current invention, there are many devices available on the market which have IP communications protocol, and can therefore be directly linked to and controlled by the server 410 in each individual room, unit, or office 450. For instance many televisions now have internet connectivity and can be controlled via a network protocol by design. These devices can be integrated into the system with a control device 452 or GCC 456 or directly without use of an additional room control device 452 or GCC 456 via their chosen network protocol and a provided network connection.

In addition to the system control devices above, in some embodiments the various connected devices may have means of control independent of the system in FIG. 4, such as light switches which work in parallel or in concert with the envisioned system in FIG. 4.

In FIG. 4, there are three boxes which show three classes of user which the system contemplates in some embodiments: corporate or business users 420, invention system service providers 430, and guest/resident users 460.

Corporate or business users 420 can be broken into several broad categories: Corporate brand users 422, property management 424, distributers 426, and 3^{rd} party content suppliers 428.

Corporate brand users 422 are entities such as corporations owning or managing chains of hotels or corporate franchises representing chains, or other corporate entities dealing with one or more properties. The invented system allows these entities access to a number of useful tools and systems which can augment or replace many of their currently un-integrated systems.

On one embodiment, the corporate brand users 422 can access the servers 410 and retrieve data from the system relating to guests, properties and systems. For instance guest data related to a stay, such as bookings, purchases, and even information such as room preferences and entertainment choices can be used to better serve that guest and can be collected and used for analytics to offer a guest relevant advertisements. Analytics from this data could also be used to improve the corporate brand by identifying data and trends relevant to corporate management, such as what type of guest is booking what rooms, or what entertainment is popular at which locations, aiding corporate decision making.

In some instances, corporate brand users 422 may replace one or more of their current internet servers or systems, or can integrate those other systems into the invented system by running software on the server 410 which replaces or communicates with these other systems. For instance, the corporate brand user 422 could use the system connect via network protocol to separate server containing the corporate loyalty rewards program. For example, using the server 410, the corporate brand user 422 could collect data from the system for analytics, and/or could use the servers 410 to connect the loyalty rewards server to other systems such as a local POS system 444 allowing reward points to be earned or spent from directly at a specific property. Additionally, some corporate users may choose to use the servers 410 to host their loyalty rewards program directly, eliminating the need for a separate system. Other systems that can be augmented or replaced are also contemplated, such as reservation systems, corporate websites and intra-corporate communication, etc.

Property managers 426 can also interface with the contemplated system and receive similar benefits as the corporate brand users 422, and additionally can use the system for property-specific purposes. In addition to the uses above for corporate brand users 422, all of which can be used by the property managers 424, property specific systems such as the PMS and POS systems can be integrated as discussed earlier.

Another contemplated corporate or business user 420 is the equipment and system distributer 426. The distributer is the entity which manufactures and/or distributes equipment and service related to the installation and maintenance of the whole or some part of the system envisioned. The distributer 426 can, in some embodiments, use the system for analytics and maintenance, for example checking to see if each of the systems is working properly, or of some component has reporting a problem to the server. In this way the distributer can address problems from data provided by the servers 410 directly, or through the other corporate users 420, or the invention system service providers 430.

In some embodiments, there are additional 3^{rd} party content suppliers 428 which also may access the system. For instance, if the system is providing entertainment for property, such as internet radio, the 3^{rd} party content supplier 428 can use the servers 410 to accomplish this. Additionally, the 3^{rd} party content can be additional services or advertisements to the guest or resident 460, such as hotel booking through a service such as Priceline™ or advertisement and booking of a local cab service near the property, or any of the many other businesses which the user or business would benefit by access to the system.

In some embodiments, there is an invention system service provider (ISSP) 430 which oversees and supports some or all of the contemplated system, or the aspects of the system which are unique to an individual brand or property. The ISSP can offer the other users product support 432, customer service support 434, and/or a call center 436, etc.

As discussed earlier in FIG. 2, the system is designed to be used also by an end user, often a guest or resident 460 of an individual room, unit, or office. This user 460 can access the system by a smartphone 462, which is either provided by the property management or the user, which is running an application 464 designed as explained extensively above.

Additionally, as explained above, the guest or resident 460 can access any of the systems or services using a web browser 468 on any browser capable networked electronic device.

It will be understood that the invention disclosed herein could be used for any secure access system, including physical access such as doors, elevators, etc. in any building, whether a hotel, residential building, an office building, or any facility. Additionally, the invention could be used for secure access to non-physical items, such as information, It will also be understood that the various servers disclosed herein may reside on separate computing devices, but may, in any combination, be on single or multiple devices, or on a virtual cloud-based server.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A method of allowing a server system to identify a hotel guest comprising the steps of:
sending a request for identification to a user;
receiving identifying information from the user;
comparing the identifying information to stored user identification information; and
determining the users identity.

2. The method of claim 1, comprising the additional step of:
determining the location of the user.

3. The method of claim 1, wherein the identifying information is a password.

4. The method of claim 1, wherein the identifying information is biometrically acquired.

5. A system allowing system to identify a hotel guest comprising:
a networked server device;
a mobile device connected to the networked server via a network protocol;
an biometric sensor operatively attached to the mobile device; and
an application installed on the mobile device allowing the server to access biometric data from the biometric device.

6. The system of claim 5, wherein the mobile device is a smartphone.
